(19) United States
(12) Patent Application Publication
(10) Pub. No.: US 2025/0067108 A1
(43) Pub. Date: Feb. 27, 2025

(54) PLASTIC SPRING FOR DETACHABLE SLIDING DOORS

(71) Applicant: Thor Tech, Inc., Elkhart, IN (US)

(72) Inventors: Erik Plischke, Missen-Willhams (DE); Thomas Schuster, Hergenweiler (DE); Marius Schöll, Bad Hindelang (DE)

(73) Assignee: Thor Tech, Inc., Elkhart (IN)

(21) Appl. No.: 18/813,914

(22) Filed: Aug. 23, 2024

(30) Foreign Application Priority Data
Aug. 25, 2023 (DE) 10 2023 122 941.9

(51) Int. Cl. E05F 7/04; E05D 15/06

(52) U.S. Cl. CPC E05F 7/04; E05D 15/0682; E05Y 2201/222; E05Y 2800/344; E05Y 2800/422; E05Y 2800/676; E05Y 2800/70; E05Y 2900/20; E05Y 2900/512

(57) ABSTRACT

A spring element for sliding doors of recreational vehicles, in particular mobile homes or caravans, having a base body on which a strip and a spring arm are formed, wherein the spring arm is at least approximately adjustable about the axis of rotation which is stationary relative to the strip. Furthermore, a sliding door and a recreational vehicle are specified.

The invention relates to a recreational vehicle, in particular a motorhome or camper, as well as a spring element for a sliding door of a recreational vehicle and a sliding door. In particular, the invention relates to a spring element in the form of a plastic spring for detachable sliding doors.

Recreational vehicles usually have an interior. Swing doors can be used here. However, sliding doors have significant advantages. For example, it is conceivable that sliding doors are permanently connected to a rail system made of aluminum or similar. Plastic rails in which the sliding doors are not removably mounted are also conceivable.

A conventional design can have at least one of the following disadvantages. There may be disadvantages in terms of weight, variety of parts and inflexible adaptation to different vehicle chassis. In addition, the complexity for the fitter can be great, resulting in a high training requirement. High costs can also result. This is particularly true for swing doors.

Damage can also occur to hinges and locks, making the doors appear crooked. It may no longer be possible to close doors.

A great deal of assembly work may be required for repairs. If necessary, panels would then have to be replaced or reinforced.

In addition, serviceability can be low.

The object of the invention is to provide a spring element for sliding doors of recreational vehicles, a sliding door for a recreational vehicle and a recreational vehicle which enable an improved design and mode of operation.

The object is achieved by a spring element with the features of independent claim 1, a sliding door with the features of claim 10 and a recreational vehicle with the features of claim 11. Advantageous further embodiments of the invention are given in the subclaims.

The solution to the problem is given by a spring element for sliding doors of recreational vehicles, in particular mobile homes or campers, wherein a base body is provided on which a strip and a spring arm are formed, and wherein the spring arm is at least approximately adjustable about an axis of rotation which is stationary relative to the strip.

Furthermore, the object is achieved by a sliding door for a recreational vehicle, in particular a motorhome or camper, with a door leaf and at least one such spring element which is connected to the door leaf. Furthermore, the object is achieved by a recreational vehicle, in particular a motorhome or camper, with at least one such sliding door.

In an advantageous embodiment, the base body may have at least one slot arranged between the spring arm and the axis of rotation, wherein elastic deformation of the base body occurs at the slot when the spring arm is actuated. The slot can be used to specify the position at which the spring gives way. This enables an advantageous adjustment.

It is advantageous that a flank is formed on the strip and that the slot is formed along the flank between the flank and the spring arm. The flank prevents the spring arm from bending upwards when tensioned.

It is advantageous that at least the strip and the spring arm of the base body are formed in one piece. In particular, the entire base body can be formed at least substantially in one piece. This makes an advantageous design possible.

It is advantageous that the base body is formed at least substantially from a plastic. This enables cost-effective production.

It is advantageous that the spring arm is elastically deformable along its longitudinal extension. The design of the spring arm can determine the force curve, in particular the rate of increase, for example by distributing the material.

It is advantageous that the spring arm is designed in such a manner that it has a force curve that progressively increases with deformation. This can be achieved by increasing the material along the spring arm. It is also advantageous that the force required increases from around 5 N to around 15 N. This prevents the sliding door from jumping or at least makes it more difficult.

It is advantageous that at least one insertion element, in particular a fir-tree-shaped insertion element, is provided on the strip of the base body, which can be inserted into a recess, in particular a bore, of a sliding door. Such a fir tree-shaped insertion element (insertion fir tree) can be used for simple assembly on the belt. In particular, this allows removal and/or replacement at any time.

Depending on the embodiment, one or more of the following features and advantages may be realized.

A plastic suspension for sliding doors can be realized. This system makes it possible to use a new thin and light panel material. Furthermore, subsequent replacement or extensive cleaning can also be carried out easily.

In particular, the sliding doors can be easily removed and replaced after the furniture has been assembled. Damage can be repaired without high costs.

The spring element ensures that the suspended sliding door sits firmly in the rail even when the vehicle is in motion. The spring element can also prevent a stick-slip effect and ensure that the sliding door glides cleanly and smoothly. The spring element together with the glide on the underside of the panel can be made of an abrasion-resistant plastic.

The length of the spring arm can be adjusted so that the appropriate length fits into the theoretical minimum and maximum according to a tolerance study for the sliding doors and the profiles.

A reinforced flank prevents the spring arm from bending upwards when tensioned.

The rate of increase in the material thickness of the spring arm can ensure a progressive force curve. This makes it more difficult for the sliding door to bounce, as the force curve of the individual spring arm increases. Preferably, the force curve can increase from 5 N to 15 N.

A slot (material slot) can be used to correctly define the position where the spring arm yields in order to achieve a horizontal state at maximum crushing. This is particularly important when removing the sliding door. A spring element can be mounted at the top on front-side bores. Opposite glides can be fitted at the bottom in the front-side bores of the sliding door. To hang the sliding door, the spring can be briefly squeezed to the maximum, which is limited by the reinforced flank to prevent breakage.

Sliding door glides can be inserted into the bottom of the panel (door leaf) and secured against falling out with a small screw, for example. Glides can limit the panel in such a manner that rattling during driving is prevented. The limitation can be made in particular along the thickness of the door leaf. The limitation also allows the use of thinner panels. A matching profile system can have a raised section along the glides to reduce friction and store a certain amount of dirt without scratching or scraping the sliding door.

Sliding doors can be retrofitted thanks to the suspension and do not hinder the assembly process. Sliding doors can be pre-assembled decentrally and reliably. Sliding doors can be removed at any time for servicing.

Sliding doors can be removed at any time for cleaning. Panel products can be easily varied, particularly in terms of material and thickness. It is possible to replace spare parts easily and cost-effectively, wherein in the worst case a sliding door is replaced completely, but this can be done without major assembly work. A suspension can prevent the panel from jumping and the associated loosening of the lock during operation. The suspension guarantees that the sliding door glides smoothly along the rails.

In particular, the following applications can be realized. A fixed furniture construction without separation between kitchen and tall unit. A fixed tall unit with a removable kitchen module. A half-height design in which the furniture structure is at a continuous height, wherein no tall unit is provided. Furthermore, a box system can serve as a use case.

A profile located under the sliding door can ensure space for the receptacle of dirt. Simple disassembly is possible by pressing upwards. The spring element can be designed as an injection-molded part. The sliding doors can also be retrofitted during production. Assembly and disassembly is also possible without tools. The spring arm can provide the upper guide. The laterally oriented flank can specify the maximum possible deformation of the spring arm.

Further advantages and details of the invention are explained in more detail with reference to the exemplary embodiments shown in the schematic figures. In the figures:

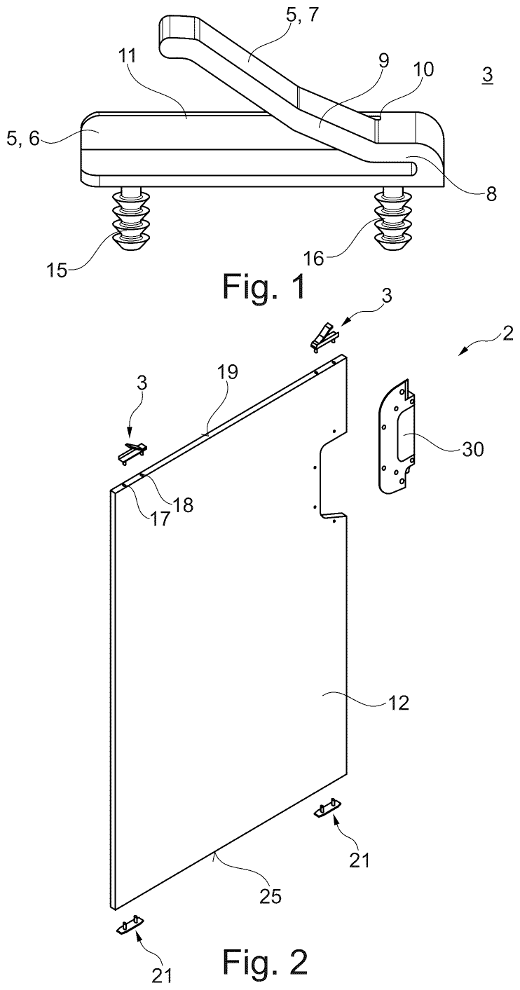

FIG. 1 shows a spring element in a schematic, spatial representation according to an embodiment example;

FIG. 2 shows a sliding door according to the embodiment example in a schematic, spatial representation in an exploded view;

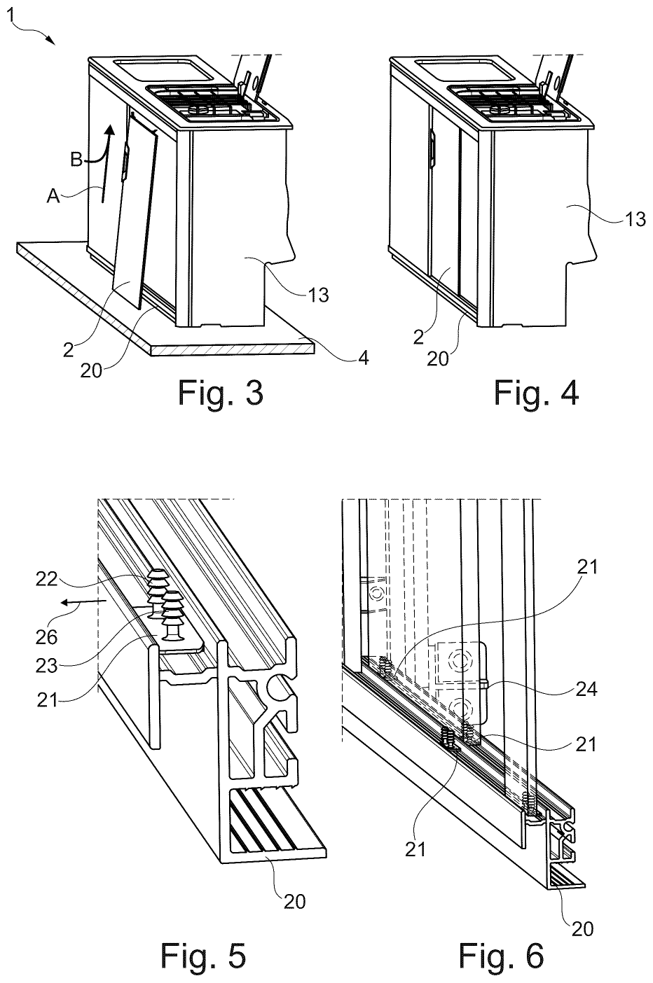

FIG. 3 shows a recreational vehicle with a piece of furniture with at least one sliding door according to the embodiment example during assembly;

FIG. 4 shows the furniture shown in FIG. 3 with the sliding door fitted;

FIG. 5 shows a profile with a glide to illustrate the embodiment and

FIG. 6 shows the profile shown in FIG. 5 with a sliding door.

FIGS. 1 to 4 show a recreational vehicle 1 with a sliding door 2 and several suspension elements 3 according to an embodiment example. The recreational vehicle 1 can be designed in particular as a motorhome or camper. A running floor 4 of the recreational vehicle 1 is shown in FIG. 3.

As shown in FIG. 1, the spring element 3 has a base body 5 on which a strip 6 and a spring arm 7 are formed. The spring arm 7 can be adjusted about an axis of rotation 8. The axis of rotation 8 can be stationary relative to the strip 6. When adjusting the spring arm 7, it may be possible to bend the spring arm 7. Additionally or alternatively, it is also possible to rotate the spring arm 7.

The base body 5 has a slot 10. The slot 10 is provided between the axis of rotation 8 and the spring arm 7. When the spring arm 7 is actuated, the base body 5 is elastically deformed at the slot 10. The spring force can be adjusted through the slot 10. In particular, a defined spring force can be specified in relation to a certain deformation. Along a longitudinal extension of the spring arm 7, a material thickness 9 can change with a certain rate of increase. This makes it possible to adjust the force curve of the spring arm 7 in relation to a deformation. In particular, a force curve that progressively increases with the deformation can be provided. The force curve can increase from around 5 N to around 15 N, for example.

In this embodiment example, a flank 11 is formed on the strip 6. The slot 10 extends along the flank 11 between the flank 11 and the spring arm 7. The flank 11 is designed as a reinforced flank 11. The reinforced flank 11 prevents the spring arm 7 from bending upwards when tensioned. The axis of rotation 8 can provide a defined point of rotation for the spring arm 7.

In a preferred embodiment, at least the strip 6 and the spring arm 7 of the base body 5 are formed in one piece. Preferably, the base body 5 is made of plastic. The plastic is preferably selected in such a manner that the spring arm 7 is elastically deformable along its longitudinal extension. A combination of plastics is also conceivable.

The strip 6 of the base body 5 has insertion elements 15, 16, which in this embodiment example are designed as insertion fir trees.

As shown as an example in FIG. 2, the insertion fir trees 15, 16 can be inserted into recesses 17, 18 of the sliding door 2 formed as bores 17, 18. In this embodiment example, the bores 17, 18 are formed on an upper end face 19 of a door leaf 12. This allows furniture 13 to be fitted with sliding doors 2 in an advantageous manner. In particular, it is easy to install. Accordingly, simple disassembly can also be realized.

FIGS. 5 and 6 show a profile 20 to illustrate the operation of a glide 21. Such glides 21 may also have insertion elements 22, 23, which may in particular be designed as fir tree-shaped insertion elements 22, 23, i.e. insertion fir trees 22, 23. In a corresponding manner, the glides 21 can be inserted into recesses, in particular bores, on a lower end face 25 of the door leaf 12, as described with reference to the spring elements 3.

The glides 21 can be guided in the profile 20 in such a manner that, in particular in a transverse direction 26, i.e. along the thickness 24 of the door leaf 12 of the sliding door 2, at least largely play-free or limited guidance is achieved.

This can prevent rattling during driving. In addition, the limitation in the transverse direction 26 enables the use of thinner panels.

A handle 30 can also be mounted on the door leaf 12.

As shown in FIG. 3, the sliding door 2 can be inserted into the guide of the furniture 13 from below in a first step A during assembly. In a second step B, the sliding door 2 is then swung in so that the glides 21 can be inserted into the profile 20. This enables reliable and simple installation.

The invention is not limited to the embodiments described.

1. A spring element for sliding doors of recreational vehicles, in particular mobile homes or caravans, having a base body on which a strip and a spring arm are formed, wherein the spring arm is at least approximately adjustable about an axis of rotation which is stationary relative to the strip.

2. The spring element according to claim 1,
characterized in that
the base body has at least one slot which is arranged between the spring arm and the axis of rotation, and in that, when the spring arm is actuated, the base body is elastically deformed at the slot.

3. The spring element according to claim 2,
characterized in that
a flank is formed on the strip and that the slot is formed along the flank between the flank and the spring arm.

4. The spring element according to claim 1,
characterized in that
at least the strip and the spring arm of the base body are formed in one piece.

5. The spring element according to claim 1,
characterized in that
the base body is formed at least substantially from a plastic.

6. The spring element according to claim 1,
characterized in that
the spring arm is elastically deformable along its longitudinal extension.

7. The spring element according to claim 1,
characterized in that
the spring arm is designed in such a manner that it has a force curve that progressively increases with deformation.

8. The spring element according to claim 7,
characterized in that
the force curve increases from approximately 5 N to approximately 15 N.

9. The spring element according to claim 1,
characterized in that
at least one insertion element, in particular a fir-tree-shaped insertion element, is provided on the strip of the base body, which insertion element can be inserted into a recess, in particular a bore, of a sliding door.

10. A sliding door for recreational vehicles, in particular motorhomes or campers, having at least one door leaf and at least one spring element according to claim 1, which is connected to the door leaf.

11. A recreational vehicle, in particular a motorhome or camper, having at least one sliding door according to claim 10.
